(19) United States
(12) Patent Application Publication
(10) Pub. No.: US 2023/0225532 A1
(43) Pub. Date: Jul. 20, 2023

(54) AUNTIE BRENDA'S "CAKE MATES - COODIE BLOCKER & WAX COLLECTOR"

(71) Applicant: Brenda R. Fogle, Washington, DC (US)

(72) Inventor: Brenda R. Fogle, Washington, DC (US)

(21) Appl. No.: 18/118,150

(22) Filed: Mar. 7, 2023

Related U.S. Application Data
(63) Continuation-in-part of application No. 16/974,353, filed on Jul. 21, 2020.

(51) Int. Cl. A47G 19/26

(52) U.S. Cl. CPC A47G 19/26; A47G 2400/061

(57) ABSTRACT

A transparent plastic or glass cover for covering a cake. The top of the cover has indentations for receiving the bottom end of small candles and supporting them vertically in place. The indentations may be configured in any desired arrangement, such as concentric circles in a circular cover for covering a circular cake, or a rectangular grid in a rectangular cover for covering a rectangular cake. The cover protects the cake from dripping candle wax and also from airborne particles landing on it, such as a spray or aerosol of saliva droplets when blowing out burning candles. The cover is then removed from the cake before the cake is sliced and served. The cover prevents germs and other contaminants from landing on the cake before it is served.

### CROSS-REFERENCE TO RELATED APPLICATION

This Application is a United States Non-Provisional Patent Application and Continuation-In-Part (CIP) Patent Application that claims priority to U.S. Non-Provisional patent application Ser. No. 16/974,353 filed on Jul. 21, 2020, which is incorporated by reference herein in its entirety.

### BACKGROUND

Prior to the onset of the Covid-19 pandemic in 2020, blowing out candles on a birthday cake was a common traditional practice. However during the pandemic blowing on food to be eaten by others became frowned upon, including blowing out candles on a cake.

### SUMMARY

A transparent plastic or glass cover for covering a cake. The top of the cover has indentations for receiving the bottom end of small candles and supporting them vertically in place. The indentations may be configured in any desired arrangement, such as concentric circles in a circular cover for covering a circular cake, or a rectangular grid in a rectangular cover for covering a rectangular cake. The cover protects the cake from dripping candle wax and also from airborne particles landing on it, such as a spray or aerosol of saliva droplets when blowing out burning candles. The cover is then removed from the cake before the cake is sliced and served. The cover prevents germs and other contaminants from landing on the cake before it is served.

It is to be understood that both the foregoing general description and the following detailed description are exemplary and explanatory and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate disclosed embodiments and/or aspects and, together with the description, serve to explain the principles of the invention, the scope of which is determined by the claims.

In the drawings:

FIG. 1A is a top view of an embodiment configured for use with a round cake.

FIG. 1B is a side view of the embodiment of FIG. 1A showing an additional schematic illustration of candles inserted in the indentations of the cover.

FIG. 1C is a schematic view showing the larger individual candles.

FIG. 1D is a schematic view of the embodiment of FIGS. 1A and 1B showing the cover removed to illustrate the sliced cake on the base plate.

FIG. 1E is a schematic view of the embodiment of FIGS. 1A and 1B showing the cover decoupled from the sidewall

FIG. 2A is a top view of an embodiment configured for use with a rectangular cake.

FIGS. 2B and 2C are front and side views of the embodiment of FIG. 2A, respectively, showing additional schematic illustrations of candles inserted in the indentations of the cover.

FIG. 2D is a schematic view of the embodiment in FIGS. 2A, 2B, and 2C showing the cover removed to illustrate the sliced cake on the base plate.

FIG. 2E is a schematic view of the embodiment of FIGS. 2A, 2B, and 2C showing the cover decoupled from the sidewall.

FIG. 2F is a sectional view in the plane indicated by line 2F-2F in FIG. 2B showing the groove in the base plate.

FIG. 2G is a view corresponding to FIG. 2F where the groove is replaced by a ridge in the base plate.

FIG. 3A is a top view of an embodiment configured for use with a cupcake.

FIG. 3B is a side view of the embodiment of FIG. 3A showing an additional schematic illustration of a candle inserted in the indentation of the top part of the cover.

### DETAILED DESCRIPTION

It is to be understood that the figures and descriptions provided herein may have been simplified to illustrate aspects that are relevant for a clear understanding of the herein described processes and devices, while eliminating, for the purpose of clarity, other aspects that may be found in typical processes and devices. Those of ordinary skill in the pertinent art may recognize that other elements or steps may be desirable or necessary to implement the processes and devices described herein. Because such elements and steps are well known in the art, and because they do not facilitate a better understanding of the present disclosure, a discussion of such elements and steps may not be provided herein. However, the present disclosure is deemed to inherently include all such elements, variations, and modifications to the described aspects that would be known to those of ordinary skill in the pertinent art.

It will be readily understood that the components of the present invention, as generally described and illustrated in the figures herein, may be realized in a variety of different configurations. Thus, the following detailed description of certain exemplary embodiments, as represented in the attached figures, is not intended to limit the scope of the invention as claimed, but is merely representative of selected illustrative embodiments of the invention. The usage of the phrases “example embodiments”, “some embodiments”, or other similar language throughout this specification refers to the fact that the feature or characteristic described may be included in at least one embodiment of the present invention, and do not necessarily all refer to the same embodiment or group of embodiments.

A variety of embodiments will now be described. These embodiments are provided as teaching examples and do not limit the scope of the invention. Although specific details of the embodiments are presented, these embodiments may be modified by changing, supplementing, or eliminating many of these details.

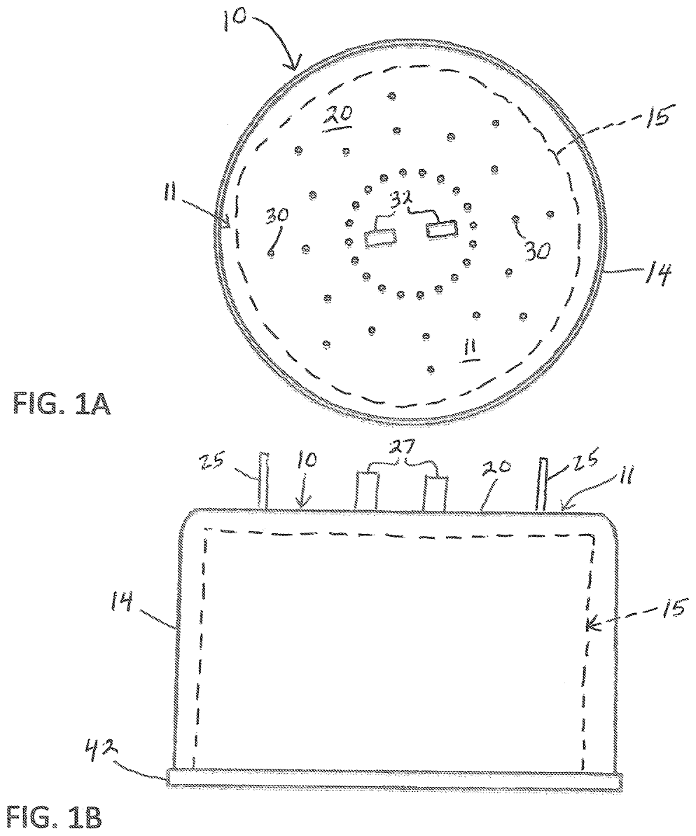

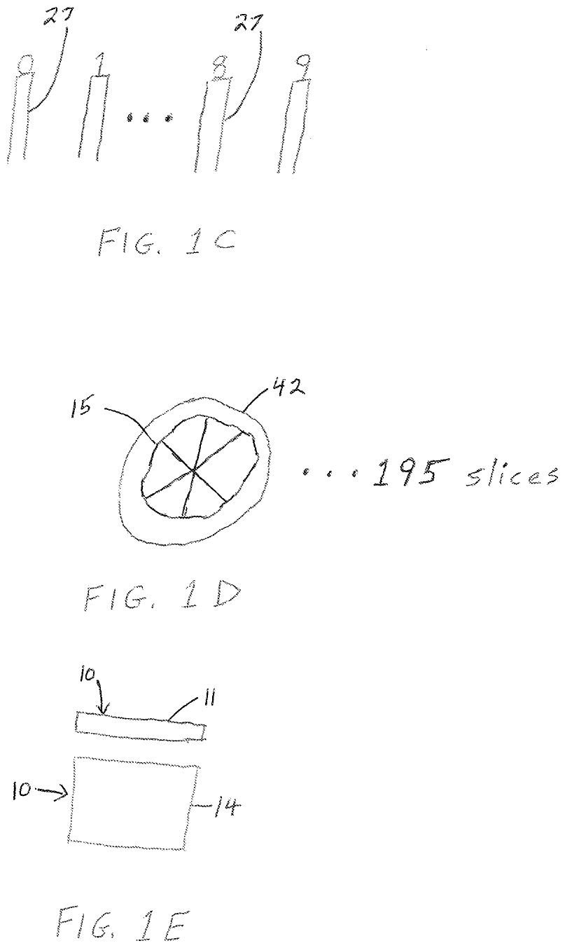

The cake covers 10, 12 are preferably made to protect standard sized birthday cakes 15, 17 having conventional shapes, for example circular or rectangular cakes, and conventional heights, such as six inches or four inches tall. In addition, the top surfaces 20, 22 of the protective cake covers 10, 12 are also configured to serve as holders for birthday candles, such as candles that can display a number of years by using that number of individual birthday candles 25, or larger individual candles 27 in the form of numeric digits. The numeric digits of the candles 27 range from 0 to 9, as shown in FIG. 1C.

In general, the covers 10, 12 may be sized with dimensions chosen to accommodate cakes 15, 17 of a variety of standard or other sizes and shapes. The covers 10, 12 are preferably made of a transparent material that is dish washer safe, such as clear glass or plastic. Other aspects of the covers 10, 12 may be based on or determined by the size and shape of the respective cakes 15, 17 being covered.

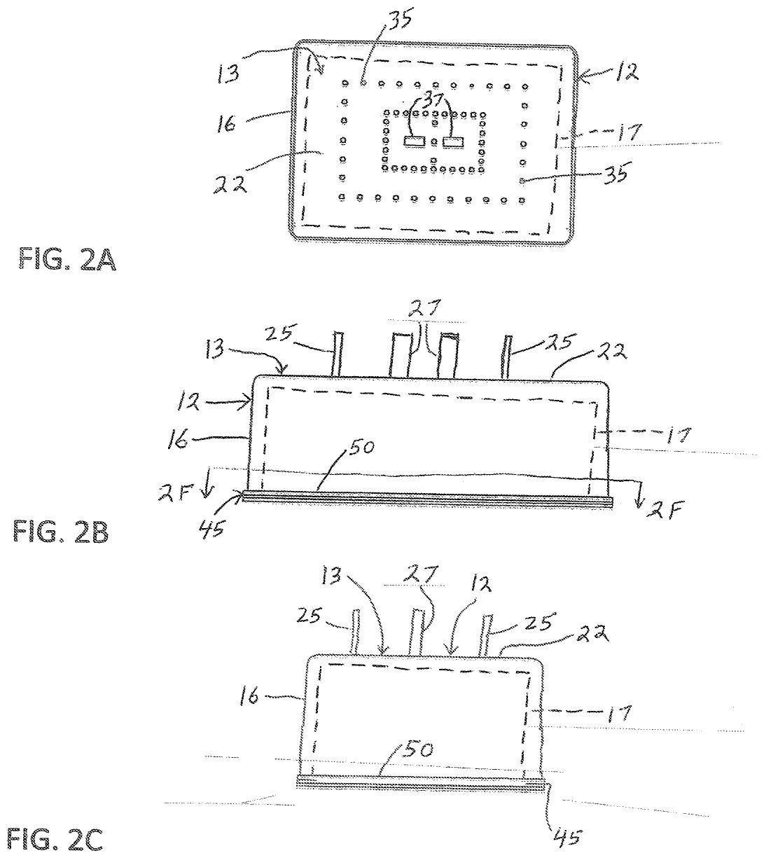

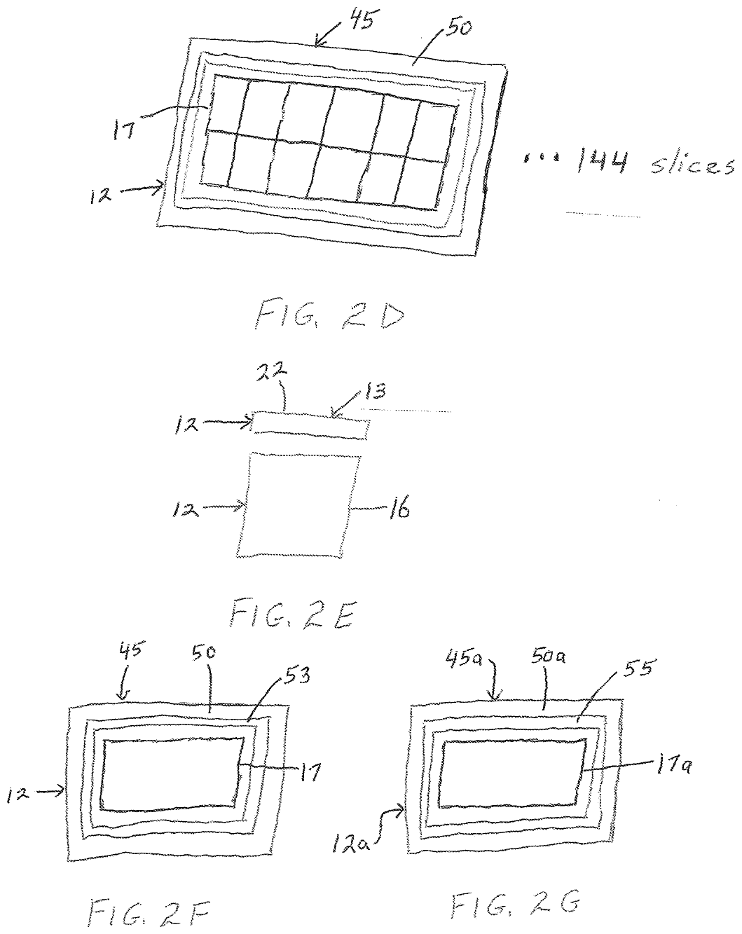

For example, a cake cover 10 may be shaped and sized to cover a round cake 15. Common dimensions of such a cake commonly include a circular plan 14″ (inches) in diameter×7″ high, including a generous amount of icing. However, round cakes 15 may commonly have a diameter in the range of 5 inches to 25 inches, and may be cut to provide 6 to 195 slices or servings, as shown in FIGS. 1D, 2D, for example. A rectangular cake may be cut to provide 12 to 144 slices. The cake 15, 17 may be cut while remaining on the base plate 42, 45, as shown in FIGS. 1D, 2D.

Embodiments of the cake covers 10, 12 may be sized accordingly to cover the iced cake plus a desired clearance so the cover does not touch the cake. The cake covers 10, 12 should comprise a transparent plastic or glass cover. The covers 10, 12 each have respective horizontal tops 11, 13 and vertical sidewalls 14, 16. The couplings between the tops 11, 13 and sidewalls 14, 16 may be permanent, as shows in FIGS. 1B, 2B, and 2C. Alternatively, the couplings between the tops 11, 13 and sidewalls 14, 16 may be temporary, as shown in FIGS. 1E and 2E. FIGS. 1E and 2E show the covers 10, 12 removed from the sidewalls 14, 16.

The respective top surfaces 20, 22 of the tops 11, 13 have respective indentations 30, 35 for receiving the bottom end of the small candles 25 and supporting them vertically in place. The indentations 30, 35 may be in the form of circular cylinders deep enough to firmly support candles 25 inserted into them, such as a quarter inch deep although other depths may be used without changing the scope of the claims. Moreover, the indentations 30, 35 may be configured in any desired arrangement, such as concentric circles in a circular cover 10 for covering a circular cake 15, or a rectangular shape or grid in a rectangular cover 12 for covering a rectangular cake 17. The covers 10, 12 protect the respective cakes 15, 17 from dripping wax from the candles 25, and also from airborne particles landing on the cake, such as a spray or aerosol of saliva droplets created when blowing out burning candles, or when coughing or sneezing in the vicinity of the cakes. The covers 10, 12 are then removed from the respective cakes 15, 17 before they are sliced and served. In addition to melted wax from the candles 25, the covers 10, 12 prevent germs and other contaminants from landing on the cakes 15, 17 before they are served.

FIGS. 1A and 1B show top and side views, respectively, of an exemplary embodiment suitable for covering a round cake 10. FIG. 1A shows one embodiment of indentations 30, 32 or candle holder positions in the top surface 20 of the cake cover 10, although other configurations may be used without changing the scope of the claims. As shown, two large rectangular indentations 32 are disposed symmetrically beside the center of the top surface 20 of the cake cover 10 for holding numeral-shaped candles 27. There is also a plurality of smaller indentations 30 for holding birthday candles, disposed in a plurality of positions configured for easy placement of candles 25 in symmetrical patterns. The indentations 30 are placed in three concentric rings with centers coinciding with the center of the top surface 20 of the cover 10. The outermost ring has eight positions 45° apart; the next ring has 12 positions 30° apart, and the innermost ring has 20 positions 18° apart. Of course, other positions may alternatively or additionally be used. FIG. 1B is a side view of the same cake cover 10. The cover 10 has a width and height configured to fit over a round cake 15, with an inside diameter larger than the diameter of the cake, and a height greater than the height of the cake, so the cover does not touch the cake. The cover 10 can be configured and manufactured to provide any convenient spacing between the cover and the cake 15. For example, the cover 10 can be sized to provide a half inch clearance around the side and top of the cake 15, such as a cover 15″ in diameter and 7.5″ tall that covers a round cake 14″ in diameter and 7″ tall to provide a 0.5″ clearance. Of course, other dimensions of the cover 10 may be used to provide different clearances, or to cover cakes of other sizes, or both.

FIGS. 2A, 2B, and 2C show top, front, and side views, respectively, of an exemplary embodiment suitable for covering a rectangular cake 17. FIG. 2A shows one embodiment of indentations 35, 37 or candle holder positions in the top surface 22 of the cake cover 12, although other configurations may be used without changing the scope of the claims. As shown, two large rectangular indentations 37 are disposed symmetrically left and right of the center of the top surface 22 of the cake cover 12 for holding numeral-shaped candles 27. There is also a plurality of smaller indentations 35 for holding birthday candles 25, disposed in a plurality of positions configured for easy placement of candles in symmetrical patterns. The indentations 35 are placed in two concentric rectangles with centers coinciding with the center of the top surface 22 of the cover 12. The outermost rectangle has 32 indentations 35 or candle holder positions evenly spaced along the circumference of the outermost rectangle, while the innermost rectangle has 32 indentations or candle holder positions evenly spaced along the circumference of the innermost rectangle. The embodiment illustrated in FIG. 2A also has three positions or indentations 35 disposed symmetrically along a centerline of the cover 12 within the inner rectangle of indentations or candle holder positions. The cover 12 has length, width, and height dimensions configured to fit over a rectangular cake 17, so the cover does not touch the cake. The cover 12 can be configured to provide any convenient spacing between the cover and the cake 17. For example, the cover 12 can be sized to provide a half inch clearance around the sides and top of the cake 17, such as a cover 18″ long, 12.25″ wide, and 6.5″ tall that covers a rectangular cake 17″ long, 11.25″ wide, and 6″ tall, thus providing a 0.5″ clearance. Of course, other dimensions of the cover 12 may be used to provide different clearances, or to cover cakes of other sizes, or both.

In embodiments, a cover 12 for a cake 17 as described in the foregoing may include or be provided with a base plate 45 that has in its top surface 50 a shallow groove 53 or ridge 55 in the shape of the bottom of the wall(s) of the cover 12, configured to receive the bottom edge of the cover and prevent it from sliding, as shown in FIGS. 2F and 2G. Parts illustrated in FIG. 2G which correspond to parts illustrated in FIG. 2F have the same reference numeral as in FIG. 2F with the addition of the suffix “a” in FIG. 2G.

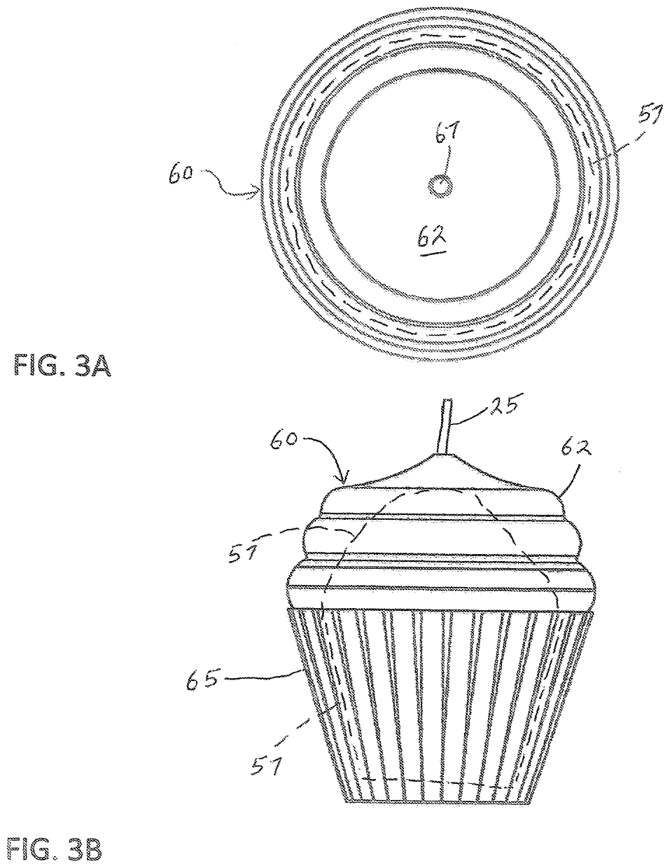

FIGS. 3A and 3B show top and side views, respectively, of an exemplary embodiment suitable for covering a round cupcake 57. In this embodiment, the cover 60 comprises top and bottom parts 62, 65. In an exemplary operation, a cupcake 57 is placed in the bottom part 65, and the top part 62 is then placed over the cupcake atop the bottom part. FIG. 3A shows one embodiment of the position of a single indentation 67 or candle holder position in the top part 62 of the cover 60 for the cupcake 57, configured to hold only one birthday candle 25 in the center of the top part, although other configurations may be used without changing the scope of the claims. FIG. 3B is a side view of the same cover 60 for a cupcake 57. The cover 60 has a width and height configured to fit over a round cupcake 57, with an inside diameter where the top and bottom parts 62, 65 meet, larger than the diameter of the cupcake, and a height greater than the height of the cupcake, so the cover does not touch the cupcake. The cover 60 can be configured and manufactured to provide any convenient spacing between the cover and the cupcake 57. For example, the cover 60 can be sized to provide a half inch clearance around the side and top of the cupcake 57 when iced, such as a cover 3″ in diameter and 3″ tall that covers a round cupcake 2″ in diameter and 2.5″ tall to provide a 0.5″ clearance. Of course, other dimensions of the cover 60 may be used to provide different clearances, or to cover cupcakes of other sizes, or both.

Although the invention has been described and illustrated in exemplary forms with a certain degree of particularity, it is noted that the description and illustrations have been made by way of example only. Numerous changes in the details of construction, combination, and arrangement of parts and steps may be made without deviating from the scope of the invention. Accordingly, such changes are understood to be inherent in the disclosure. The invention is not limited except by the appended claims and the elements explicitly recited therein. The scope of the claims should be construed as broadly as the prior art will permit. It should also be noted that all elements of all of the claims may be combined with each other in any possible combination, even if the combinations have not been expressly claimed.

What is claimed is:

1. A cake cover for safely blowing out candles on a birthday cake,
comprising: a solid transparent horizontal top having an edge;
a solid transparent vertical sidewall continuously coupled at its top edge to the edge of the horizontal top,
at least one indentation in the horizontal top configured to receive a bottom end of a candle and hold the candle upright, the indentation having an upper edge that is flush with an upper surface of the horizontal top, the indentation having a sufficient depth for the secure holding of the candle;
wherein the top and sidewall are configured to be placed over and cover a cake to prevent airborne contaminants from landing on its surface; and
wherein the airborne contaminants include COVID-19 germs.

2. The cake cover of claim 1, wherein the continuous coupling between the horizontal top and the vertical sidewall is a temporary coupling.

3. The cake cover of claim 1, wherein the continuous coupling between the horizontal top and the vertical sidewall is a permanent coupling.

4. The cake cover of claim 1, wherein the plan of the cover is one of circular for a birthday cake, rectangular for a birthday cake, and generally cone shaped for a birthday cupcake.

5. The cake cover of claim 1, wherein the candles are birthday candles and the number of indentations for holding the birthday candles is a natural number in the range of 1 to 120.

6. The cake cover of claim 1, wherein the candles are in the shape of numerals in the range of 0 to 9, and the number of indentations for holding the numerals is two.

7. The cake cover of claim 1, further comprising a base plate that has in its top surface a shallow groove or ridge in the shape of the bottom of the cover, configured to receive the bottom edge of the cover to prevent the cover from sliding.

8. The cake cover of claim 1, wherein the transparent material is glass or plastic that is safe to wash in a dishwasher.

9. The cake cover of claim 1, wherein the cake cover has a circular plan 15″ (inches) in diameter and 7.5″ tall, and the cake being covered has a circular plan 14″ in diameter by 7″ high.

10. The cake cover of claim 1, wherein the cake cover has a circular plan with a diameter in the range of 5″ to 25″ and a height in the range of 2.5″ to 10.5″.

11. The cake cover of claim 1, wherein the cake cover has a rectangular plan with dimensions 18″ long, 12.25″ wide, and 6.5″ tall, and the cake being covered has a rectangular plan with dimensions 17″ long, 11.25″ wide, and 6″ tall.

12. The cake cover of claim 1, wherein the cake cover has a rectangular plan with dimensions in the range of 12″ to 27″ long, 8″ to 19″ wide, and 2.5″ to 10.5″ tall.

13. The cake cover of claim 1, wherein the cover is sized to house a cake that can be cut into a number of servings in the range of 6 slices to 195 slices.

14. The cake cover of claim 1, wherein the cover is sized to house a cake that can be cut into a number of servings in the range of 12 slices to 144 slices.
